(19) United States
(12) Patent Application Publication
(10) Pub. No.: US 2003/0061204 A1
(43) Pub. Date: Mar. 27, 2003

(54) Systems and methods for selective information retrieval based on search source attributes

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/963,320

(22) Filed: Sep. 25, 2001

(51) Int. Cl. G06F 7/00

(52) U.S. Cl. 707/3

(57) ABSTRACT

Source selective information retrieval systems and methods. The inventive system is adapted to receive an information retrieval request from a first source. The system then ascertains an attribute of the source which is at least partially independent from the request. In the illustrative embodiment, the attribute relates to internal or external nature of the search engine from which the search request originates. The system then retrieves information from a database in response to the request and the attribute. The information retrieval system is disposed at least in part in a computing system and the first source is an external search engine connected to the computing system via a network. The system is adapted to receive an information retrieval request from a second source, an internal search engine disposed within the computing system. The inventive system would typically be implemented in a computing system such as a Web server connected to the Internet via a network interface. In this context, the internal search engine would be implemented in software on the computing system side of the network interface and the external search engine would be implemented in software on the network side of the network interface.

### BACKGROUND OF THE INVENTION

1. Field of Invention

This invention relates to systems and methods for information retrieval. Specifically, the present invention relates to systems and methods for retrieving information via the use of search engines and other such tools.

2. Description of the Related Art

Search engines are currently widely used to retrieve information from sources of data or databases that are local relative to a user or unavailable to a user via a local, wide area, or public network such as the World Wide Web or Internet. A search engine is typically a software interface that queries a database in response to words, phrases, and/or images supplied by the user. Search engines have evolved over the years to allow a user more latitude in the specification of search parameters while providing increasing accuracy with respect to search results.

One application, of which many are familiar, involves the use of a search engine via the Internet to ascertain a lowest price for goods and/or services. A search may be conducted via a variety of independent search engines, such as, Googleₜₘ, Yahooₜₘ, Infoseekₜₘ, or Dogpileₜₘ, to name a few or via a search engine dedicated to a particular site.

Consequently, a database provided through a particular web site may receive search queries from internal, i.e., dedicated search engines as well as from external search engines. Unfortunately, inasmuch as databases are not adapted to discriminate between search requests from internal as opposed to external search engines, databases generally respond to search requests with data that is not customized with respect to the search source in accordance with the preferences of a site or database administrator.

A need is recently been recognized for an ability to customize search results based on the source of the requests. For example, a company with a web site may want to offer a lower price to potential new customers via an external search engine relative to the pricing offered to existing customers through an internal search engine. Consequently, a need exists in the art for a system or method for customizing search results based on data with respect to one or more characteristics of a search source.

### SUMMARY OF THE INVENTION

The need in the art is addressed by selective information retrieval systems and methods of the present invention. The inventive system is adapted to receive an information retrieval request from a first source. The system then ascertains an attribute of the source which is independent from the request. The system then retrieves information from a database in response to the request and the attribute.

In an illustrative application, the information retrieval system is disposed at least in part in a computing system and the first source is an external search engine connected to the computing system via a network. In the illustrative implementation, the system is adapted to receive an information retrieval request from a second source, an internal search engine disposed within the computing system. In this setup, the attribute relates to internal or external nature of the search engine from which the search request originates.

In an alternative embodiment, separate databases are provided, one for queries received from external search engines and the other for queries received from an internal search engine. The inventive system would typically be implemented in a computing system such as a Web server connected to the Internet via a network interface. In this context, the internal search engine would be implemented in software on the computing system side of the network interface and the external search engine would be implemented in software on the network side of the network interface.

Hence, if the search request relates to price information, the system is adapted to retrieve a first price in response to a retrieval request from the internal search engine and a second price in response to a retrieval request from the external search engine. This allows the database administrator to provide a response to the search request by which the first price is higher than the second price or vice versa. However, the inventive system is not limited to use with pricing information. The system may be used to provide selective responses with respect to the availability of other goods and/or services based on one or more attributes of the search source.

### BRIEF DESCRIPTION OF THE DRAWINGS

FIG. 1 is a block diagram of an illustrative embodiment of a selective information retrieval system based on search source attributes implemented in accordance with the teachings of the present invention.

FIG. 2 is a flow diagram of an illustrative embodiment of a selective information retrieval method based on search source attributes implemented in accordance with the teachings of the present invention.

FIG. 3 is a block diagram of an alternative illustrative embodiment of a selective information retrieval system based on search source attributes implemented in accordance with the teachings of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

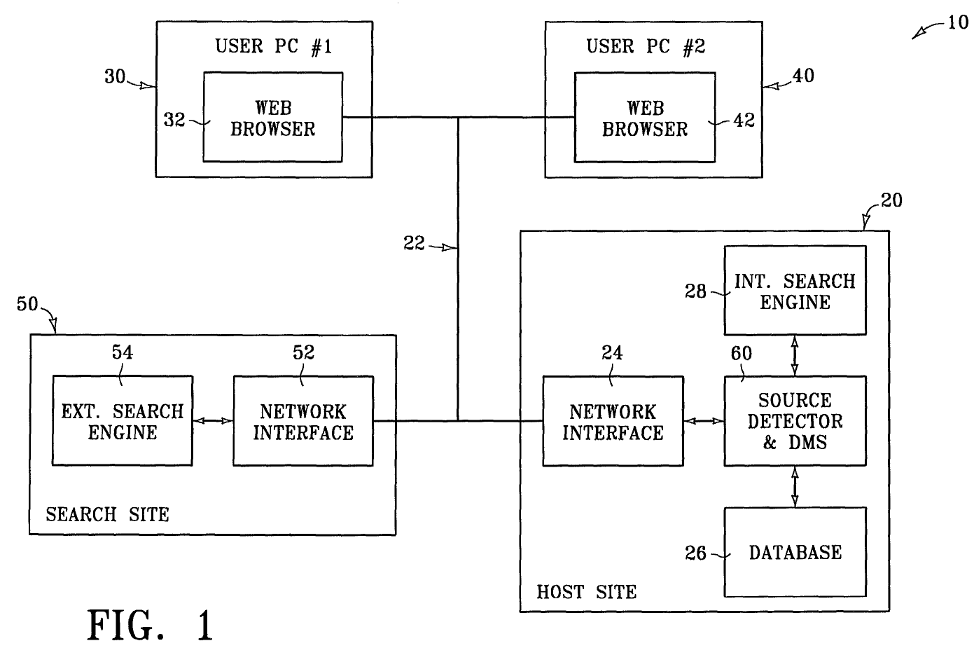

FIG. 1 is a block diagram of an illustrative embodiment of a selective information retrieval system based on search source attributes implemented in accordance with the teachings of the present invention. As shown in FIG. 1, the inventive system 10 includes a host site 20 to which first and second users are connected via a first and second user computing devices (i.e. PDAs, personal computers, cell phones, printers, internet appliances, etc.) 30 and 40, respectively. In the illustrative application depicted in FIG. 1, the host site 20 is a web site adapted to connect to the Internet 22 via a network interface 24. (Those skilled in the art will appreciate that the Internet 22 could be replaced with an intranet without departing from the scope of the present teachings.) Each user communicates with the Internet 22 via a Web browser 32 or 42.

For the purpose of illustration, assumed that the first user (30) browses to a search site 50 via its network interface 52. The search site 50 may be one of a variety of independent search sites, such as, Googleₜₘ, Yahooₜₘ, Infoseekₜₘ, or Dogpileₜₘ, to name a few. Each of these independent search sites has a search engine 54. As is well known in the art, search engines are programs implemented in software adapted to provide a database query tool with a user-friendly interface. The search engines provided by the above-noted independent search sites are adapted to go out over the Internet and retrieve information relating to the user's search request. Hence, in response to a search request from the first user (30), the search engine 54 searches databases associated with a number of web sites including the database 26 of the web site 20 via the network interface 24 thereof. In response, a database management system (DMS) 60, if provided, retrieves information from the database 26 and supplies it to the user (30) and via the search engine 54 of the search site 50. If no DMS 60 is provided, the database 26 is queried by the search engine 54 directly.

Now, assume that the second user (40) browses to the host site 20 directly and initiates a search via the internal search engine 28 thereof. Those skilled in the art will appreciate that many web sites are now equipped with internal search engines. (For the purpose of this application, an ‘internal’ search engine is defined as a search engine that is implemented locally with respect to a database and an ‘external’ search engine is defined as a search engine that is implemented remotely with respect thereto.)

Typically, the database 26 will return the same information in response to a search request received from the first user via an external search engine as the database 26 will return to the second user via the internal search engine in response to the same search request.

As mentioned above, a need has been recognized for a system or method for selectively retrieving information from the database 26 based on an attribute of the search source such as, in the present example, the location of the search engine through which the search request is received. For example, to attract new customers, a web site or a database administrator may want to quote a higher price for a product to a user that is already a customer of the host enterprise relative to prices quoted to users that are not customers who may be accessing the database remotely.

Conventionally, no mechanism was provided for selectively retrieving data in response to a given search request in response to an attribute of the search that is independent from the content of the request per se. However, in accordance with the present teachings, this capability is provided via a source detector and database management system 60.

In the illustrative embodiment, the source detector 60 may be implemented in software but the simple provision of a flag bit associated with searches processed by the internal search engine 28. As an alternative, searches received externally may be flagged. The DMS is optional and may be incorporated into the internal or external search engine or the database 26.

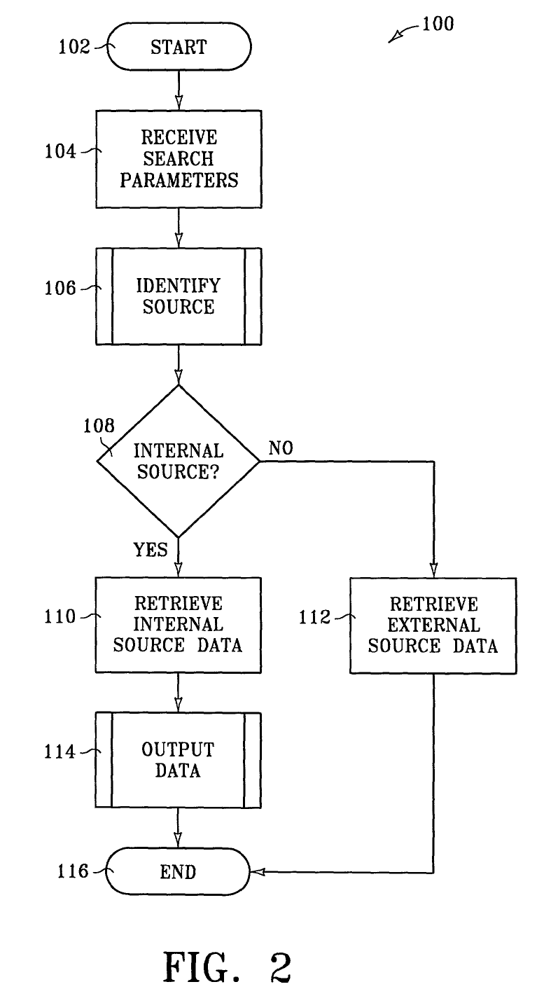

FIG. 2 is a flow diagram of an illustrative embodiment of a selective information retrieval method based on search source attributes implemented in accordance with the teachings of the present invention. As shown in FIG. 2, the inventive method 100 includes the steps 104 of receiving search parameters from a user 30 or 40 via a search engine. At step 106, the method identifies a relevant attribute of the source. In the illustrative embodiment, the attribute relates to the location of the search engine through which the request is received to relative to a hosted database. Those skilled in the art will appreciate that other attributes, at least partially independent of the content of the search request, may be used as well. For example, the attribute may relate to the actual location of the search initiator. This information may be provided by the user, the user's Internet Service Provider (ISP), or other suitable system. This information would be useful for collection of state and local taxes as well. In this case, information relating to state and local taxes would be maintained in the database and retrieved along with any pricing appropriate for the user and the transaction.

Next, at step 108, in the illustrative application, the method 100 tests for whether the source is an internal search engine or an external search engine. If the source of the search request is the internal search engine, then, at step 110, internal source data is retrieved. If, on the contrary, the source of the search request is an external search engine, then at step 112, data is retrieved that is targeted to the user of the external search engine. In any case, at step 114, the information retrieved from the database is forwarded to the requesting search engine.

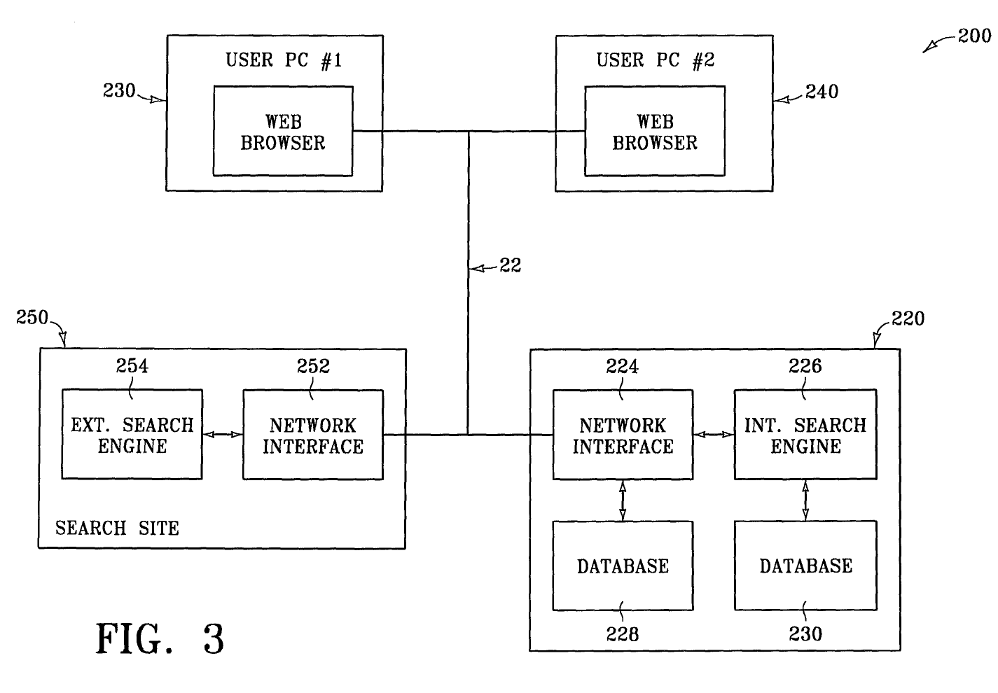

FIG. 3 is a block diagram of an alternative illustrative embodiment of a selective information retrieval system based on search source attributes implemented in accordance with the teachings of the present invention. The alternative embodiment 200 is substantially similar to the embodiment 10 of FIG. 1 with the exception that separate databases and 228 and 230 are used in place of the single database 26 of FIG. 1. In this embodiment, search requests received via the network 22 are forwarded directly to the first database 228 and search requests originating onsite are forwarded to the second database 230. Each database is provided with information suitable for a user depending upon the manner by which the user is accessing the data.

Those skilled in art will appreciate that with respect to the embodiments of FIG. 1 and FIG. 2, requests received from external search engines may be received and processed directly, whereas requests received from an internal search engine would be received via a web site (not shown) provided at the host site 20 or 220. In either case, as will be appreciated by those skilled in the art, the present invention provides for selective information retrieval based on a predetermined attribute of a search source.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A selective information retrieval system disposed at least in part in a computing system and comprising:
first means for receiving an information retrieval request from a first source, said first source being an external search engine connected to said computing system via a network, or from a second source, said second source being an internal search engine disposed within said computing system, said information retrieval request relating to price information;
second means for ascertaining an attribute of a source of said request, said attribute being at least partially independent from said request and relating to an internal or external nature of the search engine from which the search request originates; and
third means for retrieving information in response to said request and said attribute, said third means including means for retrieving a first price in response to a retrieval request from said first source and a second price in response to a retrieval request from said second source.

2. The invention of claim 1 wherein said first means includes a network interface.

3. The invention of claim 2 wherein said network interface is a Web interface.

4. The invention of claim 2 wherein said network interface is an intranet interface.

5. The invention of claim 1 wherein said second means is a source detector.

6. The invention of claim 5 wherein said third means includes a database management system.

7. A selective information retrieval system comprising:
first means for receiving a first information retrieval request from a first source;
second means for retrieving a second information retrieval request from a second source; and
third means for retrieving information from a first database from said first source in response to said first request and for retrieving information from a second database from said second source in response to said second request.

8. A selective information retrieval method including the steps of:
receiving an information retrieval request from a first source;
ascertaining an attribute of said source, said attribute being independent from said request; and
retrieving information in response to said request and said attribute.

9. The method of claim 8 wherein said attribute relates to whether said source is internal or external.

10. The method of claim 8 wherein said attribute relates to the location of a user.

11. The method of claim 10 wherein said information includes a tax rate for said user at said location.
